(19) United States
(12) Patent Application Publication
(10) Pub. No.: US 2019/0322878 A1
(43) Pub. Date: Oct. 24, 2019

(54) Transparent Luminescent Coatings, Materials, and Methods of Preparation

(71) Applicant: Bambu Vault LLC, Lowell, MA (US)

(72) Inventors: George Jia, Newton, MA (US); M. Glenn Horner, West Roxbury, MA (US)

(73) Assignee: Bambu Vault LLC, Lowell, MA (US)

(21) Appl. No.: 16/388,723

(22) Filed: Apr. 18, 2019

Related U.S. Application Data
(60) Provisional application No. 62/659,491, filed on Apr. 18, 2018.

(51) Int. Cl. C09D 5/22; C09D 133/12; C09D 7/40

(52) U.S. Cl. CPC C09D 5/22; C09D 7/69; C09D 133/12

(57) ABSTRACT

A luminescent coating includes a polymer and one or more emissive species dispersed within the polymer. The one or more emissive species absorb light within the range of about 330 nm to 420 nm and emit visible light in the range of about 530 nm to about 600 nm. The luminescent coating may be substantially transparent and colorless when illuminated by visible light, but emits visible light when illuminated by UV light.

### CROSS-REFERENCE TO RELATED APPLICATION(S)

This application claims priority to and the benefit of U.S. Provisional Patent Application No. 62/659,491, filed Apr. 18, 2018, which is incorporated herein by reference in its entirety.

### FIELD OF THE INVENTION

The present invention, according to some embodiments, relates to luminescent coatings, materials useful for luminescent coatings, and methods for preparing luminescent coatings.

### SUMMARY OF THE INVENTION

The present invention, in some embodiments, provides a luminescent coating which is configured to provide visible emission under specific illumination. In some embodiments, a luminescent coating of the present invention may be substantially transparent and/or substantially colorless under visible light while providing visible emission when illuminated by, for example, an ultraviolet (UV) light source. In some embodiments, a luminescent coating of the present invention may be configured to absorb no or a minimal amount of visible light. Thus, in some embodiments, a luminescent coating according to the present invention may be substantially invisible to a human observer until the coating is illuminated by a predetermined excitation wavelength.

In some embodiments, a luminescent coating according to the present invention includes one or more phosphors configured to provide visible emission at a predetermined wavelength of light when illuminated by a light source configured to provide an predetermined excitation wavelength. In some embodiments, for example, the one or more phosphors are configured to provide a peak emission from about 530 nm to about 600 nm in response to an excitation light source that emits in the range of about 330 nm to about 420 nm.

In some embodiments, a luminescent coating according to the present invention includes a polymer and one or more emissive species dispersed within the polymer. In some embodiments, the one or more emissive species are selected to, for example, absorb light within the range of about 330 nm to 420 nm and emit visible light in the range of about 530 nm to about 600 nm. In some embodiments, the luminescent coating is transparent or substantially transparent when illuminated by visible light. In some embodiments, the luminescent coating does not substantially absorb light above 420 nm. In some embodiments, the polymer includes one or a mixture of acrylates, styrenes, vinyl pyridines, fluoroethylene vinyl ether polymers, polyurethanes, polyesters, and polycarbonates. In some embodiments, the one or more emissive species includes terbium ions (e.g., Tb³⁺). In further embodiments, the one or more emissive species further includes one or more sensitizers configured to transfer energy to the terbium ions. The one or more sensitizers may include, for example, cerium ions (e.g., Ce³⁺) and/or europium ions (e.g., Eu²⁺).

In some embodiments, the one or more emissive species may be contained in an inorganic matrix material that is dispersed within the polymer. In some embodiments, the one or more emissive species are contained in silicate glass particles that are dispersed within the polymer. In some such embodiments, the silicate glass particles have a size of less than 20 μm in broadest dimension. In some embodiments, the silicate glass particles have a median particle size of less than 20 In further embodiments, a difference in the refractive indices of the silicate glass particles and the polymer may be less than 5%, less than 2%, or less than 1%.

Luminescent coatings described herein according to embodiments of the present invention may be applied to a substrate, for example, a solid surface. The luminescent coating may be painted or printed onto the substrate, for example, in a predetermined pattern. The substrate may be transparent or translucent, for example, a vehicle or building window, a display screen, or touch screen. The substrate may be made from glass or plastic (e.g., polyester). In some embodiments, the present invention provides a luminescent system which includes a substrate and a luminescent coating applied to the substrate. The luminescent coating may be any of the luminescent coatings described herein. In some embodiments, the luminescent system includes a substrate and a luminescent coating applied to the substrate, where the luminescent coating includes a polymer and one or more emissive species dispersed within the polymer. In some embodiments, the one or more emissive species are selected to, for example, absorb light within the range of about 330 nm to 420 nm and emit visible light in the range of about 530 nm to about 600 nm. In some embodiments, the luminescent system further includes an excitation source configured to emit light in a wavelength which would excite the one or more emissive species of the luminescent coating. The excitation source may be, for example, a UV light source that is configured and positioned to expose the luminescent coating to the excitation light. In some embodiments, the excitation source is configured to emit light within the range of about 330 nm to about 420 nm at the luminescent coating. In some embodiments, both the substrate and the luminescent coating are transparent or substantially transparent when the one or more emissive species are not exposed to the light emitted by the excitation source. In some embodiments, the luminescent coating is not visibly discernable from the substrate when the luminescent coating is not exposed to the excitation light (e.g., light within the range of about 330 nm to about 420 nm).

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings various example embodiments. It should be understood, however, that the invention can be embodied in different forms and thus should not be construed as being limited to the illustrated embodiments set forth herein.

FIG. 1 shows the excitation and emission spectra of an example luminescent coating according to an embodiment of the present invention including LUMIFLON® 916F doped with Ce³⁺ and Tb³⁺;

FIG. 2 shows the excitation and emission spectra of an example luminescent coating according to an embodiment of the present invention including ELVACITE® 2014 doped with Tb³⁺;

FIG. 3 shows the excitation and emission spectra of an example luminescent coating according to an embodiment of the present invention including ELVACITE® 2014 doped with Ce³⁺ and Tb³⁺;

FIG. 4 shows the excitation and emission spectra of an example luminescent coating according to an embodiment of the present invention including NEOCRYL® B851 doped with Ce³⁺ and Tb³⁺;

FIG. 5 shows the excitation and emission spectra of an example luminescent coating according to an embodiment of the present invention including NEOCRYL® B805 doped with Eu³⁺;

FIG. 6 shows the emission and excitation spectra of SrCl₂—SiO₂:Eu²⁺, Tb³⁺ and MgCl₂ SiO₂:Eu²⁺, Tb³⁺;

FIG. 7 shows the emission spectrum of an example luminescent coating according to an embodiment of the present invention including NEOCRYL® B805 doped with Tb³⁺, Ce³⁺;

FIG. 8 shows the emission and excitation spectra of an example luminescent coating according to an embodiment of the present invention including Dy³⁺ doped NEOCRYL® B851;

FIG. 9 shows the emission and excitation spectra of an example luminescent coating according to an embodiment of the present invention including Nd³⁺ doped NEOCRYL® B851;

FIG. 10 shows the emission and excitation spectra of an example luminescent coating according to an embodiment of the present invention including nanophosphor of La(C₂H₃O₂)₃:Ce³⁺,Tb³⁺ embedded in NEOCRYL® B851; and

FIG. 11 shows the emission and excitation spectra of LaCl₃:Ce³⁺,Tb³⁺ embedded in SiO² (1:10).

### DETAILED DESCRIPTION

Transparent luminescent coating materials are typically fluorescent paints that appear transparent or pale under daytime lighting, but will glow upon excitation under certain visible wavelengths of light. The present disclosure, in some embodiments, is directed to transparent luminescent coating materials that have a “least visible appearance” that under appropriate illumination, light emission can be bright enough to be seen at any time of day. The “least visible appearance” is to not only maintain high transparency but also remain colorless in the coating. As such, both optical scattering and absorbance at visible wavelengths are minimized according to some embodiments of the present invention.

In some embodiments, luminescent coatings may be produced using a commercial, blue emitting organic dye. While these coatings can be effectively excited using, for example, a 385 nm light emitting diode (LED) source, the resulting emission at about 430 nm may produce insufficient luminance to be viewed by a human observer in bright sunlight. It has been found that the small Stokes shift of most organic dyes makes them poor choices for producing bright luminance from a UV light source. According to the present invention, insufficient brightness in sunlight may be addressed, in some embodiments, by shifting the emission of the luminescent coatings from about 430 nm to, for example, approximately 540-550 nm, which is closer to the peak of the photopic sensitivity curve. In some embodiments, in order to achieve this type of performance, the Stokes shift of the emitter must increase significantly, beyond that typically achievable in organic dyes, so that the illumination can still be performed with the current excitation source. Use of a dye or dyes with smaller Stokes shift would require optical absorption at longer blue wavelengths, leading to a yellowish appearance for the luminescent coating when not excited.

To achieve the least visible appearance when not lit as well as strong emission when properly excited, materials are required to have strong absorption in wavelengths outside of the visible spectrum, for example in the UV spectrum, according to some embodiments. In some embodiments, this may include deep ultraviolet (DUV 200-280 nm or UV C-band) and/or UV (280-320 nm or UV B-band) and/or near UV (NUV, 320-380 nm or UV A-band) for down conversion light emission. In some embodiments, coating materials of the present invention may absorb slightly in the visible wavelengths, for example, up to about 420 nm. In some embodiments, coating materials may also include or alternatively include infrared (IR, >700 nm) absorption for up conversion light emission, where the emission occurs at wavelengths that are shorter (higher energy) than those of the absorption. In either case, if there is a strong visible absorption, a body color, representative of the reflected wavelengths of a white light illuminant, is usually seen. Therefore, even if the overall transparency is high, such a colored coating is easily noticeable and may be undesirable under certain circumstances.

While fluorescent organic dyes can absorb at UV wavelengths, the Stokes shift associated with such materials is usually limited so that the emission occurs only at blue wavelengths. To achieve longer wavelength emissions (e.g., green or yellow-red), in some embodiments, inorganic materials may provide both the required Stokes shift and quantum efficiency for useful applications.

Greater Stokes shift may be achievable using phosphors, but these materials may have a large particle size and high refractive index, that may lead to significant scattering. This scattering may cause the underlying object to be apparent under general light conditions, even when not illuminated, which may be undesirable. For example, 50034 LUMILUX® Effect Blue SN has a d50<65 μm, so that the median particle size can still be expected to be about 50 μm. While the refractive index may not be known, in certain embodiments, the specific gravity of 3.5-4.0 g/cm³ is in a range for which the expected refractive index to be about 2.5, such that scattering may be very high when incorporated into an organic polymer with a refractive index around 1.5.

Transparency of a material requires that a coating material exhibit a minimal amount of scattering according to some embodiments. Scattering results from significant reflection and refraction at interfaces of particles with other materials in which they are embedded and with which there is a large difference in refractive index. Particulate materials embedded in carriers with a similar refractive index do not show significant scattering. Similarly, if the size of the particles is much smaller than the wavelength of illuminating light, then the light will not be refracted, but will act as a dissolved component to change the average refractive index of the carrying matrix.

Luminescent coating materials have been made in accordance with various embodiments of the present invention which may exhibit one or more desirable characteristics, for example, high transparency, low absorption of visible light, no or minimal visible color when not illuminated by an excitation light source, and strong emission in the peak photopic sensitivity range (e.g., 530 nm-600 nm) when illuminated by an excitation light source. Some embodiments of transparent luminescent coating materials according to the present invention include, for example, polymer coating materials embedded with emissive centers, polymer coating materials embedded with bound emissive centers, and polymer coating materials embedded with nanophosphors, where “emissive” means that the material can emit light upon external excitation, and where “centers” include emissive chemical components such as transition metal ions, rare earth ions, molecular complexes, crystalline phosphors, dyes, or other substances, alone or in combination, that generate light via electronic optical transitions.

Polymer Coating Materials Embedded with Emissive Centers.

Polymers are very large molecules constructed from repeating monomer subunits. Polymers may be constructed from organic or inorganic materials, but most commonly are composed of carbon, hydrogen, oxygen, and a few other organic chemical atoms. Polymers are usually not as rigid as inorganic solids. While certain arrangements of monomers can lead to crystalline structures, many polymers maintain a glassy state as a solid. Phase transitions are characterized as crystalline/melt (melting point, Tₘ, when it exists) and glass/melt (glass transition temperature, T_{g}). Glass and melt transitions are low compare to most inorganic solids.

In some embodiments, a salt or other compound of an emissive ion may be incorporated into a polymer. To achieve good performance, according to some embodiments, the concentration of the ion must be high enough to absorb significant amounts of light from an excitation source (e.g., UV illuminant) so as to get bright emission. Factors to consider include the choice of polymer to acceptably dissolve the inorganic salt and the relative solubilities of the polymer and the inorganic species in the solvent chosen as the fluid carrier. In some embodiments, multiple inorganic ions are used to get good UV absorption, with energy transfer to the desired emitter being a requirement of the system. To get efficient energy transfer, in some embodiments, the distance between the ions are minimized. In some embodiments, the high concentrations used can be problematic, leading to self-quenching of the emissive state.

Among the relaxation modes for excited phosphors or inorganic ions is non-emissive internal conversion to return to the ground state. Internal conversion occurs by vibrational cascade that results from energy exchange with a surrounding host medium. In some embodiments, this host can be an inorganic matrix such as in a phosphor composition. In another embodiment, the host can be an organic polymer matrix containing the emissive ion. Since internal conversion reduces the population of excited ions, it is preferred that the matrix or polymer phonons do not couple well with the phonons of the excited species. In an embodiment, an organic polymer may provide an excellent environment to an emissive center since it does not provide a good high frequency phonon resonance with the ionic emitter. Therefore, a polymer may be preferred since phonon relaxation is weak compare to inorganic phosphors.

In conventional phosphors, the energetic ordering of electronic states is strongly affected by the symmetry and strength of the crystal field created by the host matrix. Such control is not possible in the case of ions carried in amorphous polymer matrices, however. As a result, the absorption and emission bands are expected to be energetically much broader, reflecting the range of environments that the ions may experience (inhomogeneous broadening). This will be the case for s-p, p-p, d-f, and d-d transitions, since these are very sensitive to the ligand field. For most f-f transitions, the energy levels are strongly localized on the ion, resulting in only small changes to the emission color.

In some embodiments, emissive ions for use in the luminescent coatings may include one or more rare earth ions (lanthanides and actinides), such as La, Pr, Gd, Eu, Tb, Ce, Er, Yb, Ho, Tm, Sm, Dy, Pm, Nd, Ac, Th, Pa, U, Mp, Pu, Am, Cm, Bk, Cf, etc., and/or one or more transition metal ions, such as Sc, Ti, V, Cr, Mn, Fe, Co, Ni, Cu, Zn, Y, Zr, Nb, Mo, Tc, Ru, Pd, Ag, Cd, Lu, Hf, Ta, W, Re, Os, Ir, Pt, Au, Hg, as well as Bi, Sb, Ga, In, Tl, and any of their combinations. In some embodiments, metal ions also include ionic salts or molecular complexes, including bimetallic compounds or complexes.

In some embodiments, it is desirable to bind the emissive materials to the matrix polymer. By making the emitter a component of the matrix structure, the solubility of the component can be increased, thereby decreasing the occurrence of aggregation or association of the emitter that can reduce emission efficiency through self-quenching. In the case of organic dyes, covalent bonding of the dye to the matrix can be accomplished by using linking structures that can be joined to functional groups on the polymer as a pendant modification. In some embodiments, where the matrix is formed in the presence of the emitting species, for example, by condensation polymerization, then the use of multiple functional structures on the dye can lead to incorporation into the polymer main chain.

Since bonding to inorganic ions is typically ionic rather than covalent, the polymer must be selected or designed to comprise chemical groups that are capable of binding to metallic emissive ions. These ligand groups are usually attached through pendant side chains. In some embodiments, examples of binding groups may include hydroxyl, sulfhydryl, amine, and carbonate. If the pendant ligand provides a stronger bond to the ion than its initial counterions, then binding with the polymer can be accomplished by equilibrium of the dissolved ion with the dissolved polymer. Upon binding luminescent metallic ions, the polymer can glow upon excitation by an appropriate source. In some embodiments, the ion may be bound to a single side chain ligand, with the remaining valencies occupied by counterions or ligands previously attached to the ion. In some embodiments, polymers can be designed with multiple ligands localized to behave as chelating agents to produce a particularly strong bond to the polymer.

Polymers are relatively low density materials when compared to inorganic phosphors. As a result, the refractive indices of polymers are usually similar to the silica glasses used for windows and other common transparent media. Polymers coated on glass do not create a highly refractive interface, which contributes to high transparency of the structure. In some embodiments, preferred polymers include (but are not limited to) acrylates, such as copolymers of hydroxyethyl acrylate and of acrylic acid; styrenes, such as 4-hydroxystyrene; vinyl pyridines, such as 4-vinylpyridine; as well as fluoroethylene vinyl ether polymers, polyurethanes, polyesters, and polycarbonates. Commercially available polymers, for example, NEOCRYL® B851, NEOCRYL® B805, and ELVACITE® 2014, which are acrylic copolymers and polymer mixtures, and LUMIFLON® 916F, a low molecular weight polyol that is used for the preparation of fluorinated polyurethanes may also be used for luminescent coatings according to some embodiments.

In some embodiments, preparation of a transparent luminescent coating includes the preparation of a coating fluid that comprises all of the material components, including a solvent; placing a fluid material on a substrate; and drying the fluid to remove the solvent carrier. Preparation of the coating fluid requires the combination of the chemical components in a way that the materials are uniformly dissolved or dispersed in a fluid carrier. In order to incorporate the inorganic components as a uniform dispersion, the polymer and the inorganic components must be soluble in a common solvent or solvent mixture. The polymer concentration is chosen to achieve acceptable viscosity and coating characteristics. If the concentration is too low, then the fluid will not remain in place during the subsequent drying process, and acceptable dried coating thickness may not be achieved. In some embodiments, additional surfactants, dispersants, and rheology modifiers can also be added to facilitate the homogeneity of the formulation and the coating properties of the fluid.

In some embodiments, the concentrations of dyes and inorganic ions is determined from the solubilities and the optical absorption characteristics of each species. It is desirable that the concentration of the absorbing species be high enough in the dried coating to absorb a significant amount of the energy of illumination, but not so high as to cause self-quenching of the emissive excited states. In cases where energy transfer is desired or required, in some embodiments, the minimum concentrations must be high enough to reduce the distances between energy donors and acceptors to a few tens of nanometers.

In some embodiments, one or more emissive ions, salts thereof, or molecular complexes thereof are incorporated in the selected polymer. In some embodiments, a salt of the emissive ion is dissolved with the selected polymer in a solvent. In some embodiments, the emissive ions may include rare earth ions (lanthanides and actinides), such as La, Pr, Gd, Eu, Tb, Ce, Er, Yb, Ho, Tm, Sm, Dy, Pm, Nd, Ac, Th, Pa, U, Mp, Pu, Am, Cm, Bk, Cf, etc., and transition metal ions, such as Sc, Ti, V, Cr, Mn, Fe, Co, Ni, Cu, Zn, Y, Zr, Nb, Mo, Tc, Ru, Pd, Ag, Cd, Lu, Hf, Ta, W, Re, Os, Ir, Pt, Au, Hg, as well as Bi, Sb, Ga, In, Tl, and any of their combinations. In some embodiments, the metal ions also include ionic salts or molecular complexes, including bimetallic compounds or complexes. In some embodiments, for example, the emissive ion is or includes europium (Eu³⁺). In some embodiments, europium acetate is dissolved in a solution containing the selected polymer and a solvent to form a coating solution. In some embodiments, the emissive ion is or includes terbium (Tb³⁺). In some embodiments, terbium acetate is dissolved in a solution containing the selected polymer and a solvent to form a coating solution.

In some embodiments, most (>50%) of the Tb³⁺ emission falls in a band centered at 542 nm with a full width at half maximum (FWHM) of about 10 nm, with other peaks located at 490 nm, 583 nm, and a weak peak at 621 nm. The expected improvement in luminance from this emission is clear from the location of the principal band near the maximum of the photopic sensitivity curve at 555 nm.

A further advantage of Tb³⁺ for use in luminescent coatings, according to some embodiments, is that Tb³⁺ has very little visible absorption. Its 4f-4f transitions are forbidden transitions by spectroscopic selection rules, so the absorptivity is low, even for sharp peaks. In most common phosphor hosts, the 4f-5d absorption, on the other hand, is a strong, allowed transition located above 330 nm due to the effects of the host crystal field. Since this transition lies outside of the visible band, Tb³⁺-doped materials are expected to be colorless when the host material is transparent or white.

In certain embodiments, Tb³⁺ emission may not be sufficiently strong unless it is excited through its 4f-5d absorption band. Most Tb³⁺-doped phosphors are used to provide useful visible emission from fluorescence lamps (300-365 nm excitation), and high-pressure mercury lamps (254 nm excitation). Since deep ultra violet (DUV) light is not healthy to the human body, using a DUV source to obtain efficient Tb³⁺ emission may not be desirable under some circumstances.

In some embodiments, Tb³⁺ emission may be sensitized by other absorbers (sensitizers). Tb³⁺ has a high concentration quenching threshold so that Tb³⁺ can have a relatively high doping concentration. This fact makes Tb³⁺ easier to sensitize, since the donor-acceptor distance, R, can be kept relatively small. Since the rate of energy transfer scales by R⁶, sensitization can effectively compete with other photophysical relaxation processes.

Ce³⁺ is a very good sensitizer for many other luminescent centers. Energy transfer from Ce³⁺ to Tb³⁺ has been shown to be efficient. Ce³⁺ is the first rare earth ion in lanthanide series. Due to its electronic structure, its optical transition arises from an 4f-5d transition which is broad and strong. In some embodiments, if Ce³⁺ is used as a sensitizer, the strong absorption bands for a Ce³⁺ and Tb³⁺ combined system can be easily located in the near ultra violet region (NUV), eliminating visible absorption and the discoloration that would result, while remaining useful for excitation by a UVA I source.

In some embodiments, a luminescent coating may be produced by incorporating Tb³⁺ and a sensitizer (e.g., Ce³⁺) into a polymer matrix. In some example embodiments, compounds of Tb³⁺ and Ce³⁺ may be mixed with acrylic copolymers and polymer mixtures, such as for example, NEOCRYL® B851, NEOCRYL® B805, and ELVACITE® 2014. These polymers are soluble in organic solvents such as methyl-acetate, toluene, and EGME. In some embodiments, Ce³⁺ and Tb³⁺ compounds, such as Ce(NO₃)₃, Tb(NO₃)₃, CeCl₃, TbCl₃ etc., are water soluble creating a challenge to mix the ions into the polymer systems. Since the polymer systems are not compatible with polar solvents such as ethanol, in some embodiments a minimum amount of water may be used with high concentrations of the Ce³⁺ and Tb³⁺ compounds to coordinate to the —OH groups of the polymer. In some embodiments, drying can be carried out at a modest temperature to avoid degradation of the polymer by water and acids.

In some embodiments, if Tb³⁺ nitrate is used as the ions, the desired reaction may be:

Polymer-OH+Tb(NO₃)₃→Polymer-OTb(NO₃)₂+HNO₃

Polymer-OH+Polymer-OTb(NO₃)₂→(Polymer-O)₂TbNO₃+HNO₃

Polymer-OH+(Polymer-O)₂TbNO₃→(Polymer-O)₃Tb+HNO₃

The three possible products, with each Tb³⁺ ion bound to one, two, or three polymer hydroxyls, means that the doped polymer product will contain some residual nitrate ion. In some embodiments, however, this can lead to oxidation of the polymer and a brownish residue in the coating.

Tb³⁺ is not the highest valence state of terbium, existing as well as Tb⁴⁺. Tb⁴⁺ has dark brown color and does not emit. If it exists in the formulation, Tb⁴⁺ could bind to an additional—OH side group on the polymer to lead to a tetracoodinate ion.

Polymer-OH+(Polymer-O)₃TbNO₃→(Polymer-O)₄Tb+HNO₃

Since Tb³⁺ has dark brownish color, if a large number of Tb³⁺ ions turn into Tb³⁺ then the product may appear as a dark brownish or black coating. However, it has been found that the product polymer remains colorless before it is coated, so oxidation of Tb³⁺ to Tb⁴⁺ is not a serious concern according to some embodiments.

In some embodiments, when the solution is coated on a substrate and dried (e.g., a polyester substrate and dried at 80° C.), the green emission of Tb³⁺ can be observed by eye when illuminated with a 360 nm source. In some embodiments, however, residual nitrate residues may lead to a brownish coating, making the unilluminated coating visible and attenuating the intensity of the green emission. To avoid the presence of nitrate ion in the coating, in some embodiments terbium (3+) chloride and terbium (3+) acetate may be used instead of terbium nitrate. On coordination of the terbium ion in the polymer, chloride ion produces hydrochloric acid which catalyzes degradation of the polymer. Residual acetate presents no such problems, and is generally more compatible in the organic polymer.

While the emission from Tb³⁺ occurs at a wavelength that improves the luminance of the emitting sample, the absorbance may not be high enough to provide strong green emission that can compete with sunlight. Therefore, in some embodiments, a sensitizer, for example Ce³⁺, can be beneficial to sensitize the terbium emission. In some embodiments, for example, both cerium acetate and terbium acetate can be incorporated together into the polymer to introduce the Tb³⁺ and Ce³⁺ ions. However, if the blue Ce³⁺ emission appears very bright and dominates the emission, the energy transfer from Ce³⁺ to Tb³⁺ may be weak. It should be appreciated that other sensitizers that are effective to transfer energy to the Tb³⁺ may also be used according to further embodiments, for example, Eu²⁺.

In some embodiments, the concentration of all ions in the polymer is about 1% by weight to polymer, which is estimated to be near the limit based on hydroxyl functionality of the polymer. The influence of distance between donor and acceptor on energy transfer rate is given by

k_{FRET}→E²˜(μ_{D}μ_{A}/R_{DA}³)²=μ_{D}²μ_{A}²/R_{DA}⁶

where μ_{D} and μ_{A} are the dipoles of the donor (Ce³⁺) and acceptor (Tb³⁺), respectively and R is the average distance between energy donors (Ce³⁺) and acceptors (Tb³⁺). As a result, if the concentration of the donor is too low, then the distance between donor (Ce³⁺) and acceptor (Tb³⁺) will be too great to get the desired sensitization since it is proportional to 1/R⁶. At a concentration of about 0.5% for each component, the average distance would be on the order of 70 Angstroms, which may be too far to achieve adequate energy transfer.

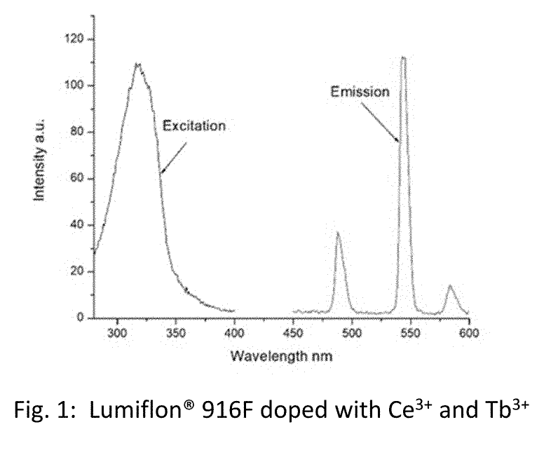

In further embodiments, a luminescent coating may be prepared by incorporating one or more emissive ions into a fluoroethylene vinyl ether polymer, for example, commercially available as LUMIFLON® 916F. LUMIFLON® 916F is a low molecular weight polyol that is used for the preparation of fluorinated polyurethanes. In some embodiments, LUMIFLON® 916F that may be doped with ions using cerium (3+) and terbium (3+) acetate. In some such embodiments, a strong, broad excitation can be observed at 315 nm that is associated with the emission at 542 nm. FIG. 1 shows excitation and emission spectra of LUMIFLON® 916F that has been doped with ions using cerium (3+) and terbium (3+) acetate according to an example embodiment. This excitation is not likely to originate in the terbium ions, since shifting the terbium 4f-5d transition to this wavelength would require a significant crystal field that cannot arise in the polymer matrix. This excitation could arise from Ce³⁺, although shifting the cerium absorption would also require a strong crystal field. Alternatively, this excitation might be associated with electronic excitation of the (non-luminescent) polymer itself.

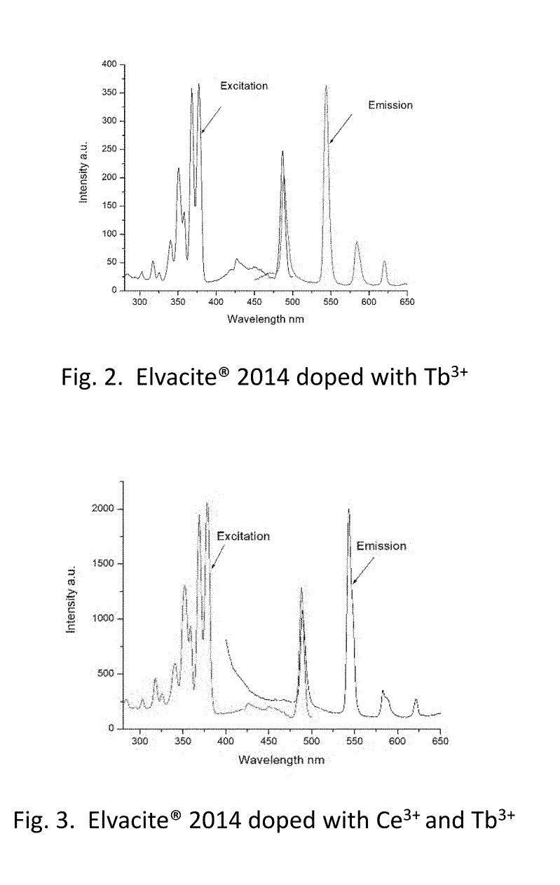

In some embodiments, a luminescent coating may include ELVACITE® 2014 doped with Tb³⁺. FIGS. 2 and 3 show emission and excitation spectra of ELVACITE® 2014 doped with Tb³⁺, and with the Ce³⁺ and Tb³⁺ pair of ions, respectively, according to certain example embodiments. In some embodiments, the resulting emission was not intense enough to compete with reflected sunlight. However, if the sunlight is shadowed, then an image can be seen. The Tb³⁺ emission at 542 nm has higher luminance, due to its yellowish green color, than the blue emission of previously used dyes. Both Tb³⁺ excitation spectra in both FIGS. 2 and 3 are very similar, with weak, sharp excitations of Tb³⁺ without a trace of Ce³⁺ absorption. The low intensity of the observed emission indicates that Ce³⁺ to Tb³⁺ energy transfer is very inefficient. Thus, there is almost no Ce³⁺ sensitizing effect to Tb³⁺ in these examples. From comparison of the spectra in FIG. 2 and FIG. 3, the low intensity emission on the blue side of the peak in FIG. 3, which does not occur in FIG. 3 for the Tb³⁺ alone, is due to a Ce³⁺ emission that extends into the visible region from its peak in the NUV. It also proves that Ce³⁺ does not transfer any significant energy to Tb³⁺, since the Ce³⁺ emission would be considerably reduced by the energy transfer to terbium.

In contrast to the LUMIFLON® polyol, the ELVACITE® polymer contains little hydroxyl functionality that would bind the dopant ions. As a result, one of the major issues is that Tb³⁺ concentration is very low in this formulation. For example, in FIG. 3, the 410 nm and 430 nm emission peaks normally only appear when doping concentration is below 0.2% mole percent in a solid phosphor; at higher concentrations, excitation in higher energy states is quenched to produce the desired, lower energy state that emits at 542 nm.

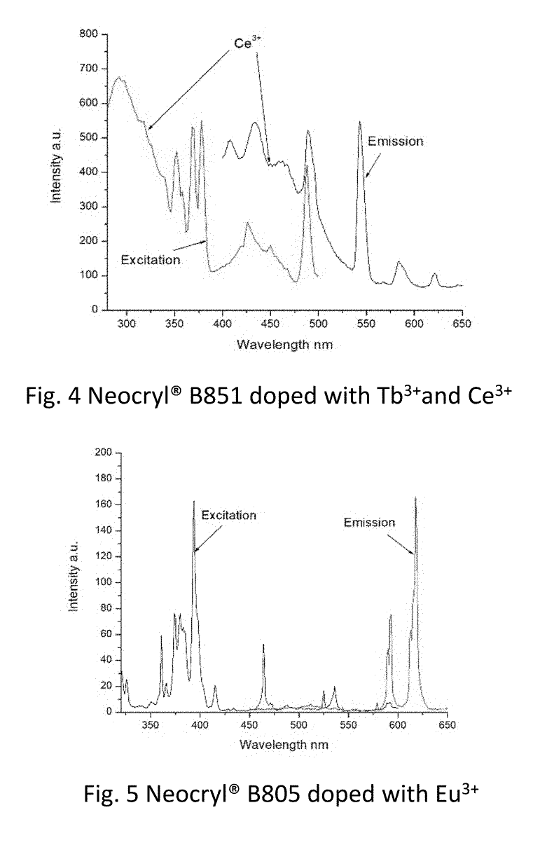

In some embodiments, a luminescent coating may include NEOCRYL® B851 doped with Ce³⁺ and Tb³⁺ ions. NEOCRYL® B851 is an acrylic polymer with pendant hydroxyethyl functionality. Evidence that Ce³⁺ can been incorporated into the polymer is shown in FIG. 4. The 290 nm absorption and 425 nm emission peaks are very much as expected for Ce³⁺. Unlike LUMIFLON®, the NEOCRYL® polymer has no aromatic moieties that can act as UV absorbers near 300 nm. If doping the polymer with d-state ions is successful, then doping with ions such as Mn′, Cr′ etc. is also possible according to some embodiments. Successful doping with a d-state ion is very important evidence that binding to the polymer is successful. Observation of emission from cerium ions is important evidence that the ions are adequately dispersed in the polymer, most likely by binding with pendant hydroxyls, since aggregates or crystallites of the ions would lead to concentration quenching of any excited states produced. On the other hand, the threshold for concentration quenching for f-state ions is high, and such materials may glow without being dispersed by dissolution into anything. This is especially true for Eu³⁺ and Tb³⁺; for example, both EuCl₃ and TbCl₃ glow with UV excitation without uniformly dispersing them in a polymer solution.

While some of the above example embodiments utilized terbium ions as the emissive species, it should be appreciated that other ions may be used to produce luminescent coatings according to other embodiments. For instance, in some embodiments, a luminescent coating may include a polymer doped with Eu³⁺. FIG. 5 shows emission and excitation spectra of NEOCRYL® B805 doped with EuCl₃. While this polymer does not contain pendant hydroxyls to which ions can bind, addition of europium led to an orange-red emission that can be stimulated by illumination with 380 nm LED lamp. Since the orange-red emission is not near the peak of the photopic sensitivity curve, the luminance of this emission may not bright enough to compete adequately with reflected sunlight. However, if the image is shaded to prevent direct illumination by sunlight, the orange red color can be seen.

Polymer Coating Materials with Embedded Nanophosphors.

Phosphors are the major luminescent materials for lighting, indication, marking, etc., due to their high efficiency, high brightness, stability, and durability. For transparent materials, in some embodiments, phosphors are often formed as single crystals, transparent ceramics, glasses, etc. Those forms on their own are clear and transparent but they cannot be used as transparent materials in coatings for large areas. To deposit phosphors directly onto an object as a film is a costly and very complicated procedure. Alternatively, to incorporate such materials into film-forming polymers requires grinding of the phosphor to a modest size, usually to a range of 10-100 μm median particle size; smaller particles are ineffective emitters due to quenching by defects on the crystal structure created by the grinding. Most phosphors are inorganic compounds which have a significantly higher refractive index than the polymer into which the particles are incorporated, leading to refraction and reflection which cause scattering and increase the visibility of a coating even when it is not illuminated.

Phosphors in the form of nanoparticles (nanophosphors) offer a good alternative form to make transparent luminescent materials. Nanophosphors have a basic lattice, which is good for most of the s, p, d transitions such as arise in Bi³⁺, Cr³⁺, Mn²⁺, etc. that are very sensitive to ligands. Since the nanoparticles are much smaller than the wavelength of the illuminating light, they do not have much influence on light path by refraction and reflection. Nanophosphors, however, have issues such as aggregation, etc. that may cause them to behave as bulk particles. Aggregated particles may increase scattering and may therefore be undesirable. In some embodiments, when they are well-dispersed into a polymeric binder, the nanoparticles can remain separated and behave optically as individual small particles. In some embodiments, dispersion of nanoparticles in polymers can be facilitated by the use of dispersants and surfactants. In some embodiments, nanoparticle composites can be prepared by polymerization of a monomer in a dispersion of the monomer with nanoparticles.

In one embodiment, a nanophosphor can be prepared from inorganic components in the presence of a polymeric binder. In this case, the polymer can act both to provide viscosity to control phosphor particle growth through diffusion as well as to serve as the polymeric binder for the coating formulation. For such materials, the nanophosphor components comprise both the emissive ions and an inorganic matrix component. In an embodiment, the matrix or host material are oxides, halides, sulfides, or other compounds such as sulfate, phosphates, etc. that do not require high temperature synthesis or sintering, since polymeric binders are not resistant to high temperature.

One way to maintain the dispersion of the nanoparticles, according to some embodiments, is to create them in the presence of another matrix that inhibits the aggregation and annealing of the small particles into larger, scattering particles. In some embodiments, a method to accomplish this is to prepare the nanoparticles in a sol-gel composition. In such a process, the components required to create an initial phosphor particle can come together, but the growth of the particle is inhibited by the viscosity of the forming gel matrix, resulting in a population of nanoparticles dispersed in the gel. The gel can then be dried, and sintered, if desired, to produce a nanophosphor composition embedded in a glass.

The sol-gel component can be chosen such that the resultant glass has a refractive index comparable to the polymer to be used for the transparent coating. For example, silica sols prepared from tetraethyl orthosiloxane (TEOS) produce a silica gel that can be dried and sintered to a silica glass with a refractive index of about 1.46 according to some embodiments. In some embodiments, after incorporation of the phosphor at a concentration of about 10%, the refractive index for the composite glass is expected to be about 1.50. This value compares favorably with the refractive index of many acrylic polymers of about 1.50-1.52. Once prepared, the composite glass may be ground to a normal particle size of, for example, about 10-100 μm. These nanophosphor particles may then be dispersed in a polymer, for example, any one of the polymers described in the prior embodiments. The resultant material would not be expected to produce much scattering when dispersed in common polymers because of the close match of their refractive indices.

In some embodiments, the nano-particulate phosphor is embedded in a silicate glass. Then, the glass is ground to a normal phosphor size of less than about 20 The concentration of the phosphor in the silicate may be, for example, about 10% by weight, so it will not significantly affect the average refractive index of the larger silica particles. In one embodiment, the nano-particulate phosphor provides optical absorption in the range 365-405 nm and optical emission near 550 nm. In one embodiment, the nano-particulate phosphor has similar refractive index to the polymer in which it will be incorporated, therefore, there will be no or substantially no light scattering to reveal the location of a printed image produced by the luminescent coating.

Nanophosphor-Embedded Glass.

According to further embodiments of the present invention, nanophosphors may be embedded in glass. Using SiO₂ as an example, its glass form is generally a very porous material compared to its crystal form, quartz. Quartz has a higher density and higher refractive index than its glass form as a result of its organized (tetrahedral) crystal structure as compared to the amorphous porous glass network.

The porosity of the glass provides voids that can contain small structures of between 5 to 15 nm in size. Different glass forming conditions produce glasses of different porosities, and hence glasses with different densities and refractive indices can be produced.

When voids or impurities occur as a different phase inside a material, reflection and refraction can occur at the phase boundary and can be seen as scattering such as in the example of air bubbles in water. If such an inclusion has a dimension significantly smaller than the wavelength of light (˜300 nm in silica), however, its interaction with light is significantly reduced, and it may be considered as part of the bulk material. For the case of a piece of glass, even if there are a large number of pores, the glass is still non-scattering to visible light if the pores are sufficiently small. Its effective refractive index drops from about 1.55 (quartz) to about 1.46 as a result of the inclusion of the volume of included air.

The refractive index of mixed materials is governed by the Lorentz-Lorenz equation:

$$\frac{{n}_{12}^{2} - 1}{{n}_{12}^{2} + 2} = {Ø}_{1} \frac{{n}_{1}^{2} - 1}{{n}_{1}^{2} + 2} + {Ø}_{2} \frac{{n}_{2}^{2} - 1}{{n}_{2}^{2} + 2}$$

where n₁ and Φ₁ are the refractive index and volume fraction of the first material, n₂ and Φ₂ are the refractive index and volume fraction of the second material, and n₁₂ is the refractive index of the mixture. For phosphor nanoparticles with an average refractive index of about 2.4 embedded in a silicate glass with a refractive index of about 1.46, the refractive index of the doped glass would rise to about 1.52 with a doping concentration of about 10%.

In some embodiments, to avoid the appearance of color that accompanies absorption at visible wavelengths, the target absorption may be tailored to be in the range of 365-385 so that the material might be illuminated with available UV LEDs. Ce³⁺ and Eu²⁺ are two ions that may be used to sensitizing Tb³⁺ emission. Each of these ions has good UV absorption in the required range. In some embodiments, Ce³⁺ may perform better than Eu²⁺ to sensitize Tb³⁺.

In some embodiments, a nanocrystalline phosphor can be created that has the desired optical characteristics in an environment that can lead to embedding the phosphors in a silicate matrix. In some embodiments, the choice of host materials for the phosphor may be very important, insofar as the crystal field of the phosphor significantly affects the absorption wavelength of the phosphor. To achieve the effects of the crystal field, in certain embodiments the phosphor must be heated to produce a single phase of the host. In some instances, phosphors embedded in SiO₂ are heated to just below 900° C., a temperature that is just above SiO₂ glass densification temperature but below the temperature needed to obtain a good single-phase host structure. As a result, the phosphors obtained this way may not achieve an emission as efficient as that of a conventionally prepared, bulk phosphor.

At a high enough temperature, the process can change from incorporation of the nanophosphor into the glass to incorporation of silicate into the phosphor matrix, thereby changing the phosphor properties. This can happen at temperature around 1100° C. At such temperatures, ion mobility in SiO₂ is high enough to cause annealing of nanoparticles to grow these into larger, conventional phosphor particles in a process called “solid precipitation.” That is, a new solid phase grows and forms within another solid. Such a product will lose its transparency as a nanoparticle embedded glass.

In some embodiments, the host materials selected are very simple hosts which mostly crystallize themselves after they dry out from solution and lose water. This will avoid the high temperature requirement. In some embodiments, simple halides and oxides are used such as NaCl, CaCl₂, LaBr₃ and SrI₂ etc. and CaO, BaO and Y₂O₃ etc. Table 1 provides a list of nanoparticles according to embodiments of the present invention that have been tested.

TABLE 1
Terbium-doped nanoparticles embedded in SiO₂

| | | Absorption | Emission | SiO₂ |
|---|---|---|---|---|
| Nanoparticle host | Sensitizer | nm | nm | parts 1:N |
| BaO | Eu²⁺ | 325 | 495 | 12 |
| CaO | Ce³⁺ | 330 | 542 | 11 |
| Ca₂BO₃Cl | Ce³⁺ | 328 | 542 | 10 |
| LaCl₃ | Ce³⁺ | 313 | 542 | 7 |
| LaBr₃ | Ce³⁺ | 335 | 542 | 5 |
| YCl₃ | Ce³⁺ | 318 | 542 | 10 |
| KC1 | Eu²⁺(Eu³⁺) | 340(377) | 542(618) | 10 |
| NaCl | Eu²⁺ | 333 | 542 | 10 |
| Ca₂BaB₂O₆ | Ce³⁺ | 341 | 542 | 10 |
| CaB₂B₂O₆ | Ce³⁺ | 343 | 542 | 10 |
| BaMg₂Al₁₄O₂₄ | Eu²⁺ | 358 | 450(542) | 5 |
| Ca₂Al₂SiO₇ | Ce³⁺ | 325 | 542 | 10 |
| CaAl₂O₄ | Ce³⁺ | 356 | 542 | 11 |
| CaAl₄O₇ | Ce³⁺ | 355 | 542 | 12 |
| Ba₉Lu₂Si₆O₂₄ | Eu²⁺ | 339 | 542 | 16 |
| Sr₃SiO₅ | Ce³⁺ | 328 | 542 | 11 |
| Sr₃Al₂O₆F | Eu²⁺ | 397 | 542 | 15 |
| LiCaPO₄ | Eu²⁺ | 420 | 541(Eu²⁺) | 10 |
| GdBr₃ | Ce³⁺ | 309 | 542 | 8 |
| GdCl₃ | Ce³⁺ | 319 | 542 | 9 |
| SrCl₂ | Eu²⁺ | 395 | 542 | 10 |
| CaCl₂ | Eu²⁺ | 333 | 430(542) | 10 |
| MgCl₂ | Eu²⁺ | 350 | 542 | 10 |
| Y₂Si₂O₇ | Ce³⁺ | 339 | 542 | 12 |
| CaBaO₂ | Ce³⁺ | 325 | 542 | 10 |
| SrO | Ce³⁺ | 327 | 542 | 12 |
| Gd₂O₃ | Ce³⁺ | 327 | 542 | 10 |
| Y₂O₃ | Ce³⁺ | 333 | 542 | 10 |

In some embodiments, Eu²⁺ was selected to be the sensitizer for Tb³⁺ to achieve absorption at about 380 nm. In some embodiments, systems that paired europium with terbium are less successful than those sensitized with Ce³⁺. Once it dissolved in an acidic solvent, europium (2+) ion is very easily oxidized to its 3+ valence before it is incorporated into the silica. While Eu²⁺ compounds may be used directly, reduction of Eu³⁺ back to Eu²⁺ at temperatures below 900° C. is difficult. This becomes more problematic once the Eu²⁺ doped compound is embedded into SiO₂ glass. Eu³⁺ is not an effective sensitizer for Tb³⁺ due to poor spectral overlap between the europium emission and terbium absorption.

From Table 1, only a small portion of the samples have a NUV absorption above 350 nm. It was also found that some complex hosts, such as BaMg₂Al₁₄O₂₄, CaAl₂O₄, CaAl₄O₇, LiCaPO₄, and Sr₃Al₂O₆F, will not produce a transparent glass material. As a result, only a few, such as MgCl₂ and SrCl₂, were considered further.

Alkali earth chlorides embedded sol-gel glass, for example CaCl₂), have been intensively studied and reported to have a relatively low solid solubility. Low solubility can lead to aggregation to form larger particles that will lead to scattering of incident light. Low solubility of the halide can also lead to reaction with the surrounding silicate to produce a new, more stable, silicate phase that will no longer be formed on a nano-scale, and therefore can scatter light. MgSiO₃ and SrSiO₃ can be easily formed at 1100° C. or below. There are even more silicate phases at different mixing percentages and sintering temperatures such as Mg₂SiO₃, Sr₂SiO₃ and Sr₃SiO₃ etc. Therefore, MgCl₂ and SrCl₂ cannot be heat treated at higher temperatures to obtain better nanoparticles that glow strongly.

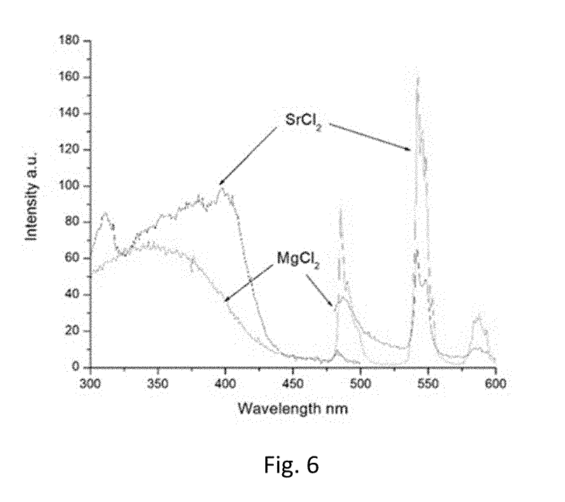

Emission and excitation spectra of SrCl₂ and MgCl₂ doped with Eu²⁺ and Tb³⁺ according to some example embodiments are shown in FIG. 6. Emissions from both nanoparticles are Tb³⁺ emissions that peak at 542 nm. Excitation spectra of the terbium emission of these two show Eu²⁺ absorption in the NUV. This indicates Eu²⁺ to Tb³⁺ energy transfer does take place. Unfortunately, in some instances, the emission intensity is not as strong as desired, for reasons discussed above. Under direct sunlight, the green emission of both of these glassy materials can be difficult to see.

Ce³⁺ and Tb³⁺ Incorporated Glass.

Emission from ions embedded in glass is not typically strong enough to compete with a phosphor. Unless doped with high enough concentration of luminescent ions, glass has not typically been considered a good option.

When matching the refractive index of prepared luminescent materials with coating materials is inadequate, in some embodiments of the present invention the nanophosphor-embedded glass may be prepared in a large format. For example, in some embodiments, a nanophosphor-embedded glass may be directly used in a window of a vehicle or building. In some embodiments, nanoparticle-embedded glass produces significant luminance as a glass.

In some embodiments, telluride glass and ZBLAN glass are made with adding small portion of Y₂O₃, B₂O₃, Tb³⁺ and Ce³⁺. In some embodiments, the mixture is heated up to 1000° C. and then quenched onto a steel plate. Such glasses can be prepared as large pieces or sheets and can be as large as needed. In further embodiments, the glass can be easily thinned by cutting and polishing. Since it is a full network, it is strong as glass, but incorporation of nanoparticles may create cracks along the nanoparticle boundaries.

In some embodiments, efforts to produce telluride glass yielded a glass with a brownish color. It was not obvious whether the color was inherent to the glass or if it resulted from the presence of Tb³⁺ produced during the glass making process. In some embodiments, Tb³⁺ emission was not observed as expected, so it is possible that Tb³⁺ ions are oxidized during glass making and contribute to the brownish color. In some embodiments, the oxidization may be avoided by producing the glass under a reducing environment to avoid this potential problem.

### EXAMPLES

### Example #1: NEOCRYL® B805 Doped with Tb³⁺ and Ce³⁺

NEOCRYL® B805 (methyl methacrylate/butyl methacrylate copolymer) was dissolved in methyl acetate to produce a 38% solution. Terbium acetate and cerium acetate were added to the stirred solution to achieve a concentration of 7% in the polymer. The fluid is diluted with additional methyl acetate, and toluene was added to comprise 20% of the total solvents. The fluid was stirred well to combine, coated at a wet thickness of 20 mils on clear polyester, and dried at 40° C. to produce a clear coating.

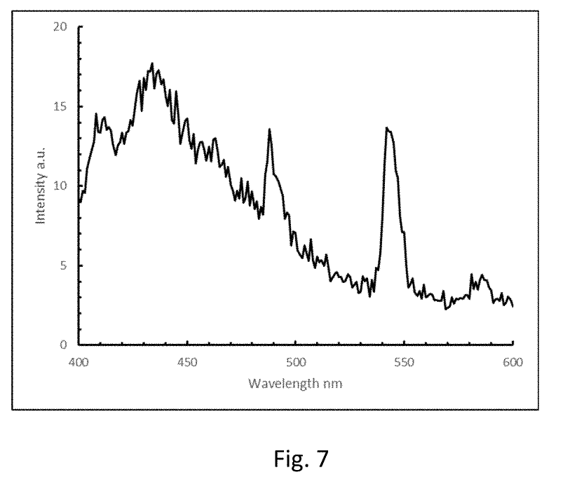

The emission spectrum of Ce³⁺, Tb³⁺ incorporated into NEOCRYL® B805 is shown in FIG. 7. Emission is very weak and shows only emission from Tb³⁺. The absence of Ce³⁺ emission may be due to its arising from a 4f-5d transition. Unlike the 4f-4f transitions of Tb³⁺, the 5d state is a delocalized state and is very sensitive to environment. In general, the generation of a strong 5d-4f emission only occurs in phosphors with a strong crystal field associated with a proper lattice.

### Example #2: NEOCRYL® B805 Doped with Eu³⁺

NEOCRYL® B805 is dissolved in methyl acetate to produce a 38% (w/w) solution. Europium acetate was added to the stirred solution to achieve a concentration of 7% in the polymer. The fluid is diluted with additional methyl acetate, and toluene was added to comprise 20% of the total solvents. The fluid was stirred well to combine, coated at a wet thickness of 20 mils on clear polyester, and dried at 40° C. to produce a clear coating.

Emission and excitation spectra are given in FIG. 5. Eu²⁺ emission and absorption are evident, with a major emission peak at 619 nm with major excitation peak at 397 nm. The emission shows much stronger intensity than that of Tb³⁺, probably due to its higher concentration.

### Example #3: ELVACITE® 2014 Doped with Tb³⁺ and Ce³⁺

ELVACITE® 2014 polymer is dissolved in toluene to produce a 38% (w/w) solution. Terbium nitrate and cerium nitrate were dissolved in methyl acetate. The concentration of Tb is estimated to be less than about 1% by weight of the polymer binder.

The dissolved terbium nitrate and cerium nitrate was then mixed with the solution of 38% ELVACITE® 2014 and stirred at elevated temperature. The solvents were then evaporated slowly at 40° C. and the polymer turned hard.

The resulting products are clear and transparent and, under UV excitation, glowed green. The emission and excitation spectra of ELVACITE® 2014 tagged with Tb³⁺ and Ce³⁺ are shown in FIG. 3. Sensitization by Ce³⁺ was not clearly evident, which could be due to the doping concentration being too low and the Ce³⁺ and Tb³⁺ ion separation distance being too far.

### Example #4: Tb³⁺ Doped ELVACITE® 2014

ELVACITE® 2014 is dissolved in toluene to produce a 38% (w/w) solution. Terbium nitrate was added to the stirred solution to achieve a concentration of less than about 1% of the polymer weight. The fluid is diluted with additional methyl acetate, and toluene was added to comprise 20% of the total solvents. The fluid was stirred well to combine, coated at a wet thickness of 20 mils on clear polyester, and dried at 40° C. to produce a clear coating.

The emission and excitation spectra of the Tb³⁺ doped ELVACITE® 2014 is shown in FIG. 2.

### Example #5: Ions Doped into NEOCRYL® B851

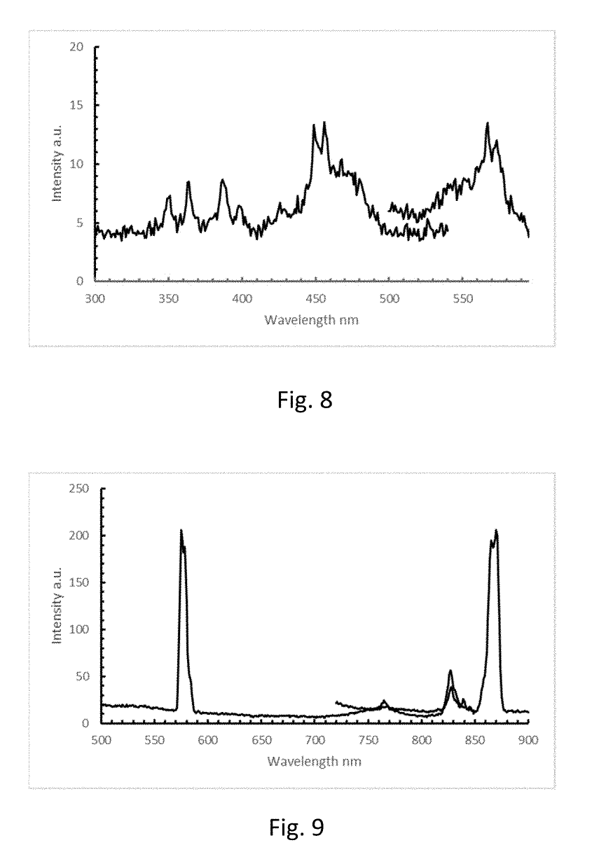

Some other ions such as Dy³⁺, Nd³⁺, Tb⁺, Ce³⁺/Tb⁺, Pr³⁺, Cr³⁺, Ni²⁺ and Mn⁴⁺ etc. may be incorporated in NEOCRYL® B851 using a similar method to that of Example #1. Emission and excitation spectra of Dy³⁺ and Nd³⁺ are given in FIGS. 8 and 9, respectively.

FIG. 4 shows emission and excitation spectra of NEOCRYL® B851 doped with Ce³⁺ and Tb³⁺. Ce³⁺ sensitization to Tb³⁺ is demonstrated from the excitation spectra of the Tb³⁺ emission measured at 542 nm. The broad 295 nm excitation is not found in the sample with only Tb³⁺ doping, so this excitation likely arises from Ce³⁺ sensitization. Since Tb³⁺ and Ce³⁺ are doped at about 100% of hydroxide group concentration, their distance could be very close at some points. In the emission spectrum, the extra blue part of the emission near 420 nm could be due to Ce³⁺ also. Similar results were also found using LUMIFLON® 916F doped with Ce³⁺ and Tb⁺, as shown in FIG. 1. Preparation of LUMIFLON® 916F doped with Ce³⁺ and Tb³⁺ is similar to that of NEOCRYL® B851. The broad excitation peak near 320 nm is unlikely to be associated with Tb³⁺, but more likely due to Ce³⁺, suggesting successful sensitization of Tb³⁺. In the case of the LUMIFLON® 916F, the peak at 320 nm may be due to LUMIFLON® 916F absorption that is subsequently transferred to the Tb³⁺.

### Example #6: Direct Embedding Nanophosphors in a Polymer

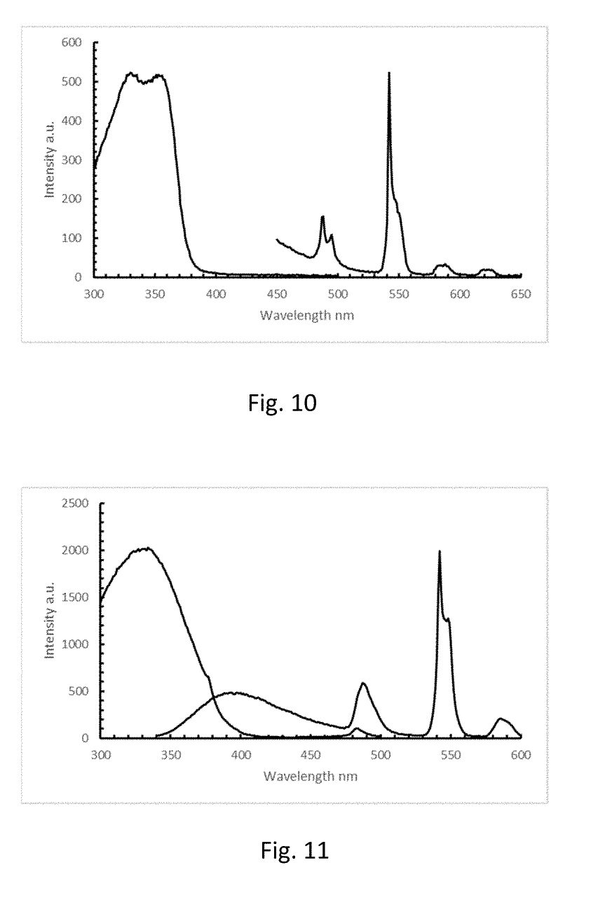

NEOCRYL® B851 was selected as the polymer, and methyl acetate is selected as solvent. A 20% mass percent solution of NEOCRYL® B851 in methyl acetate solution was made. The nanophosphor is separately prepared in lanthanum acetate as host, with Tb and Ce as co-dopants. A solution of 0.7 mol of lanthanum acetate and 0.2 mol of terbium acetate and 0.1 mole of cerium acetate was prepared in methyl acetate. The solutions of polymer and ions were then mixed and allowed to dry. A La(C₂H₃O₂)₃:Ce³⁺, Tb³⁺ nanophosphor embedded polymer was obtained. Emission and excitation spectra of La(C₂H₃O₂)₃:Ce³⁺, Tb³⁺ in NEOCRYL® B851 is given in FIG. 10. Sensitization of Tb³⁺ by Ce³⁺ is very strong.

### Example #7: Polymer with Glass Embedded with Nanophosphors

NEOCRYL® B851 was selected as the polymer for having a close refractive index to SiO₂ glass (1.52). Methyl acetate is used as solvent. A 20% mass percentage of NEOCRYL® B851 in methyl acetate solution was made. LaCl₃ was chosen as a host material while 10% mole of Tb³⁺ (TbCl₃) and 3% mole of Ce³⁺ (CeCl₃) was co-doped in LaCl₃ as emission center and sensitizer respectively. 0.01 mole of such composition, 0.7 mol of LaCl₃, 0.2 mol of TbCl₃ and 0.1 mol of CeCl₃ are dissolved in water and ethanol to make a solution. Then 0.1 mol of TEOS is diluted with ethanol. TOES and phosphor solution are mixed and distilled to a high concentration. Final solution is heated at 55° C. until a dry gel is obtained. Then the dry gel is slowly heated at 1° C./10 min in oven up to 800° C., and annealed at 800° C. in a H₂/N₂ balanced gas environment for 5 hours. A transparent dry glass is obtained with strong Tb³⁺ emission. Emission and excitation spectra are given in FIG. 11. Strong Tb³⁺ emission is observed.

The glass was then ground to <20 μm particle and blended into polymer solution and allowed to dry. A clear polymer embedded with SiO₂ sol-gel glass with LaCl₃:Ce³⁺,Tb³⁺ was obtained.

It should be understood that various changes, substitutions, and alterations can be made herein without departing from the spirit and scope of the invention as defined by the appended claims. It should also be apparent that individual elements identified herein as belonging to a particular embodiment may be included in other embodiments of the invention. Moreover, the scope of the present application is not intended to be limited to the particular embodiments of the process, machine, manufacture, and composition of matter, means, methods and steps described in the specification. As one of ordinary skill in the art will readily appreciate from the disclosure herein, processes, machines, manufacture, composition of matter, means, methods, or steps that perform substantially the same function or achieve substantially the same result as the corresponding embodiments described herein may be utilized according to the present invention.

1. A luminescent coating comprising:
a polymer; and
one or more emissive species dispersed within the polymer, the one or more emissive species being selected to absorb light within the range of about 330 nm to 420 nm and emit visible light in the range of about 530 nm to about 600 nm.

2. The luminescent coating of claim 1, wherein the luminescent coating is substantially transparent when illuminated by visible light.

3. The luminescent coating of claim 1, wherein the luminescent coating does not substantially absorb light above 420 nm.

4. The luminescent coating of claim 1, wherein the polymer comprises one or a mixture of acrylates, styrenes, vinyl pyridines, fluoroethylene vinyl ether polymers, polyurethanes, polyesters, and polycarbonates.

5. The luminescent coating of claim 1, wherein the one or more emissive species includes terbium ions.

6. The luminescent coating of claim 5, wherein the one or more emissive species further includes one or more sensitizers configured to transfer energy to the terbium ions.

7. The luminescent coating of claim 6, wherein the one or more sensitizers includes cerium ions and/or europium ions.

8. The luminescent coating of claim 1, wherein the one or more emissive species are contained in an inorganic matrix material that is dispersed within the polymer.

9. The luminescent coating of claim 1, wherein the one or more emissive species are contained in silicate glass particles that are dispersed within the polymer.

10. The luminescent coating of claim 9, wherein the silicate glass particles have a median particle size of less than 20 μm.

11. The luminescent coating of claim 9, wherein a difference in the refractive indices of the silicate glass particles and the polymer is less than 2%.

12. A luminescent system comprising:
a substrate; and
a luminescent coating applied to the substrate, the luminescent coating comprising:
a polymer; and
one or more emissive species dispersed within the polymer, the one or more emissive species being selected to absorb light within the range of about 330 nm to about 420 nm and emit visible light in the range of about 530 nm to about 600 nm.

13. The luminescent system of claim 12, wherein the substrate is substantially transparent.

14. The luminescent system of claim 12, wherein the substrate is a window, display screen, or touch screen.

15. The luminescent system of claim 14, wherein the substrate is a vehicle window.

16. The luminescent system of claim 12, wherein the substrate comprises glass or polymer.

17. The luminescent system of claim 12, wherein the luminescent coating is applied onto the substrate in a predetermined pattern.

18. The luminescent system of claim 12, further comprising an excitation source configured to emit light within the range of about 330 nm to about 420 nm at the luminescent coating.

19. The luminescent system of claim 18, wherein the luminescent coating is not visibly discernable from the substrate when the luminescent coating is not exposed to light within the range of about 330 nm to about 420 nm.

20. The luminescent system of claim 12, wherein the luminescent coating does not substantially absorb light above 420 nm.
